(19) United States
(12) Patent Application Publication
(10) Pub. No.: US 2009/0227195 A1
(43) Pub. Date: Sep. 10, 2009

(54) Systems and Methods for Treating Aircraft Cabin Air

(75) Inventors: Mark Buelow, Phillipsburg, NJ (US); Michael P. Galligan, Cranford, NJ (US); Martin Volland, Jersey City, NJ (US)

Correspondence Address: BASF CATALYSTS LLC, 100 CAMPUS DRIVE, FLORHAM PARK, NJ, 07932, US

(73) Assignee: BASF Catalysts LLC, Florham Park, NJ (US)

(21) Appl. No.: 12/398,501

(22) Filed: Mar. 5, 2009

Related U.S. Application Data
(60) Provisional application No. 61/034,743, filed on Mar. 7, 2008.

(51) Int. Cl. B60H 3/00; B64D 13/06

(52) U.S. Cl. 454/156; 454/76

(57) ABSTRACT

Air treatment systems including an environmental control system, a mixer, an air distribution duct system, and one or more catalysts for treating the air in the aircraft cabin environment are provided. Methods for treating aircraft cabin air are also provided. The air treatment systems treats compressed air provided to the aircraft cabin, which can include bleed air and bleedless air, and also treats existing air recirculated from an aircraft cabin to remove ozone, volatile organic compounds, NOx and other pollutants. The catalysts used to treat the compressed air, recirculated air and/or combined compressed and recirculated air are disposed at various stages of the air treatment systems described herein.

### CROSS-REFERENCE TO RELATED APPLICATIONS

This application claims the benefit of priority under 35 U.S.C. §119(e) to U.S. Patent Application No. 61/034,743, filed Mar. 7, 2008, which is hereby incorporated by reference in its entirety.

### TECHNICAL FIELD

Embodiments of the present application relate to air treatment systems and methods of treating the cabin air of an aircraft.

### BACKGROUND

During flight or operation of aircraft, the air within the cabin environment is continuously treated and replenished with fresh air. The existing air is continuously recirculated and filtered to remove contaminants such as viruses and bacteria, and portions of this existing air is also exhausted and replenished. The fresh air used to replenish the exhausted cabin air during operation or flight is taken in from the atmosphere, treated and then mixed with the recirculated cabin air. In some instances, the air from the atmosphere is further treated to remove pollutants.

Aircraft typically fly at higher altitudes for more fuel-efficient operation. At higher altitudes, the atmosphere contains a high level of ozone, and ozone plumes encountered at some altitudes have even higher ozone concentrations. The presence of ozone in the atmosphere can provide protection from ultra-violet rays but can also be harmful when inhaled. This air and the air existing within aircraft cabins contain many other components in addition to ozone including NOx, volatile organic compounds (“VOCs”) and other undesired compounds and particulate matter. This air from the atmosphere is typically supplied to the cabin through the engine of the aircraft. As outside air enters the compressor of the engine, it is compressed and heated to a higher pressure and temperature. The heated and pressurized air from the engine, commonly referred to as “bleed air,” is extracted from the compressor by bleed air ports which control the amount of air extracted. The bleed air is fed to an environmental control system (“ECS”).

After the bleed air passes through the catalyst and ECS, during which ozone and other pollutants may be removed and the temperature and pressure adjusted, the bleed air is sometimes circulated to the air-conditioning packs where it is further cooled to a set temperature for introduction to the cabin.

The existing air from the cabin is filtered, recirculated to the air treatment system and mixed with the bleed air. The mixture of recirculated cabin air and bleed air is then supplied to the cabin. As shown in FIGS. 1 and 2, the air treatment system of the prior art typically includes a single catalyst 407, 402. In FIG. 1, the catalyst 407 is disposed upstream of the ECS 300. In FIG. 2, the catalyst 402 is integrally formed with or disposed on the ECS 300. In accordance with one or more embodiments of the present invention, the air treatment system 200 includes one or more catalysts 400, which remove the pollutants from the compressed air, recirculated air and combined compressed and recirculated air.

An ever-increasing demand for improved fuel economy and continuously increasing cabin air quality standards require new solutions. As standards of aircraft cabins become stricter, there is also a demand for air treatment systems which use “bleedless” air, i.e., fresh air that is not supplied by the engine or engine compressor of the aircraft. Accordingly, there is a need for an air treatment system for supplying high-quality treated air to passengers during long flights at high altitudes, which meet these standards. Further, there is a need for air treatment systems which can reduce installation and service costs and provide retrofit options.

### SUMMARY

One aspect of the present invention pertains to a system for treating air to be introduced to the aircraft cabin environment. According to one embodiment of the present invention, the system for treating air includes an air distribution duct system in fluid communication with a compressor that delivers compressed air into the air distribution duct system. In one or more embodiments, the compressed air is bleed air, bleedless air or a combination of bleed and bleedless air. As used herein, “bleedless air” is defined as air which is compressed without the use of the aircraft engine. Bleedless air can include fresh air from outside the aircraft or stored air and is compressed by an air compressor or other compressor unrelated to the engine of the aircraft. As previously defined, “bleed air” is air drawn from the atmosphere that has been compressed by the aircraft engine or engine compressor. The system of one or more embodiments includes a delivery port for delivering compressed air from the compressor into the air distribution duct system and an ECS downstream from the delivery port for treating the compressed air. The delivery port, air distribution duct system and ECS are in fluid communication. The air treatment system also a recirculation air system for providing recirculated air from the cabin to the air distribution duct system and a mixer located downstream from the environmental control system and in fluid communication with air flowing from the ECS and the recirculated air. The mixer combines the compressed air flowing from the ECS and the recirculated air for delivery to the cabin.

In one or more embodiments, the compressed air, which can be bleed or bleedless air, is mixed with the recirculated air and then fed to the ECS. In a specific embodiment, the pressure, temperature, humidity and other properties of the combined compressed and recirculated air are treated by the ECS.

The air treatment system includes a catalyst for removing one or more pollutants from the air in the system. The catalyst of one or more embodiments of the present invention is adapted to remove pollutants such as ozone, VOCs, NOₓ and other undesired compounds from the compressed air, the recirculated air or both.

According to one embodiment of the present invention, the system includes a catalyst disposed downstream from the mixer to treat the combined recirculated air and compressed air. In a specific embodiment, the catalyst is disposed in fluid communication with the recirculated air. The catalyst is disposed or impregnated on an inner surface of the air distribution duct system in one embodiment. In a more specific embodiment, the catalyst is positioned to remove pollutants from the recirculated air before it is combined with the compressed air. The catalyst of one or more embodiments is in fluid communication with the combined compressed air and recirculated air. In one such embodiment, the catalyst is disposed on the mixer.

One embodiment of the air treatment system includes a second catalyst in fluid communication with the compressed air. In one specific embodiment, the second catalyst is positioned to remove pollutants from the compressed air before it is combined with the recirculated air in the mixer. In a more specific embodiment, the second catalyst is disposed or impregnated on an inner surface of the air distribution duct system.

One or more embodiments of the air treatment system includes two catalysts in fluid communication with the compressed air and disposed upstream of the environmental control system. In a specific embodiment, one of these two catalysts is integrally formed with the environmental control system. In a more specific embodiment, one of these catalysts is adapted to primarily remove ozone while the other is adapted to primarily remove VOCs. In further embodiments, one of these catalysts is adapted to remove VOCs and the other is adapted to remove ozone.

According to one embodiment, one or more catalysts can be disposed on the mixer or distribution duct system. As otherwise described herein, the catalyst can be integrally formed or disposed on the ECS.

The air treatment system can further include a filter in fluid communication with the recirculation air system, whereby the filter removes contaminants from the recirculated air. One embodiment of the air treatment system provides for an air conditioning pack in fluid communication with the ECS and mixer for cooling the compressed air. The present invention also provides for aircrafts having an air treatment system according to one or more embodiments described herein.

A second aspect of the present invention pertains to methods of treating aircraft cabin air. The method of one embodiment includes drawing compressed air to a treatment system from an engine compressor of an aircraft and catalytically removing one or more pollutants from the compressed air. The method further includes also recirculating cabin air to the treatment system and filtering the cabin air to remove contaminants. Thereafter, the method includes mixing the compressed air with the cabin air to form mixed air and delivering the mixed air to the cabin. In a second embodiment, the method of treating aircraft cabin air also includes the step of cooling the compressed air prior to mixing with the cabin air.

In one embodiment, the method further includes catalytically removing one or more pollutants from the mixed air. A second embodiment of the method provides for catalytically removing one or more pollutants from the compressed air prior to mixing with the cabin air, according to a fourth embodiment. The methods of treating aircraft cabin air described herein remove pollutants such as ozone, VOCs, NOₓ, other undesired compounds and/or combinations thereof, from the compressed air, recirculated air or the combined compressed and recirculated air.

### BRIEF DESCRIPTION OF THE DRAWINGS

A more complete appreciation of the subject matter of the present invention can be realized by reference to the following detailed description in which reference is made to the accompanying drawings depicting exemplary embodiment of the invention in which:

FIG. 1 illustrates an air treatment system according to the prior art;

FIG. 2 shows an air treatment system according to the prior art;

FIG. 3 shows a perspective view of an aircraft and an air distribution system, according to one embodiment;

FIG. 4 shows an air treatment system and aircraft cabin according to one embodiment;

FIG. 5 shows an embodiment of the air treatment system including a catalysts disposed to treat the compressed air prior to combination with the recirculated air and a catalyst disposed to treat the combined compressed air and recirculated air;

FIG. 6 illustrates an embodiment of air treatment system having a catalyst disposed to treat the combined compressed air and recirculated air;

FIG. 7 shows an embodiment of the air treatment system having a catalyst to treat recirculated air and a catalyst to treat the compressed air before the recirculated air and compressed air are combined;

FIG. 8 illustrates an embodiment of an air treatment system wherein the catalyst is disposed to treat the recirculated air;

FIG. 9 shows an air treatment system with two catalysts disposed to treat the compressed air prior to being combined with the recirculated air;

FIG. 10 shows an embodiment of the air treatment system using a bleedless air for compressed air and two catalytic systems disposed to remove pollutants from the compressed air and the combined compressed air and recirculated air;

FIG. 11 shows the air treatment system of FIG. 10 wherein one catalytic system is disposed to remove pollutants from the compressed air and the other catalytic system is disposed to remove pollutants from the recirculated air before it is combined with the compressed air;

FIG. 12 shows the air treatment system of FIG. 10 wherein a catalytic system is disposed to remove pollutants from the combined compressed air and recirculated air;

FIG. 13 shows the air treatment system of FIG. 10 where a catalytic system removes pollutants from the recirculated air before it is combined with the compressed air; and

FIG. 14 illustrates the air treatment system of FIG. 10, wherein two catalytic systems are disposed upstream of the mixer to remove pollutants from the compressed air.

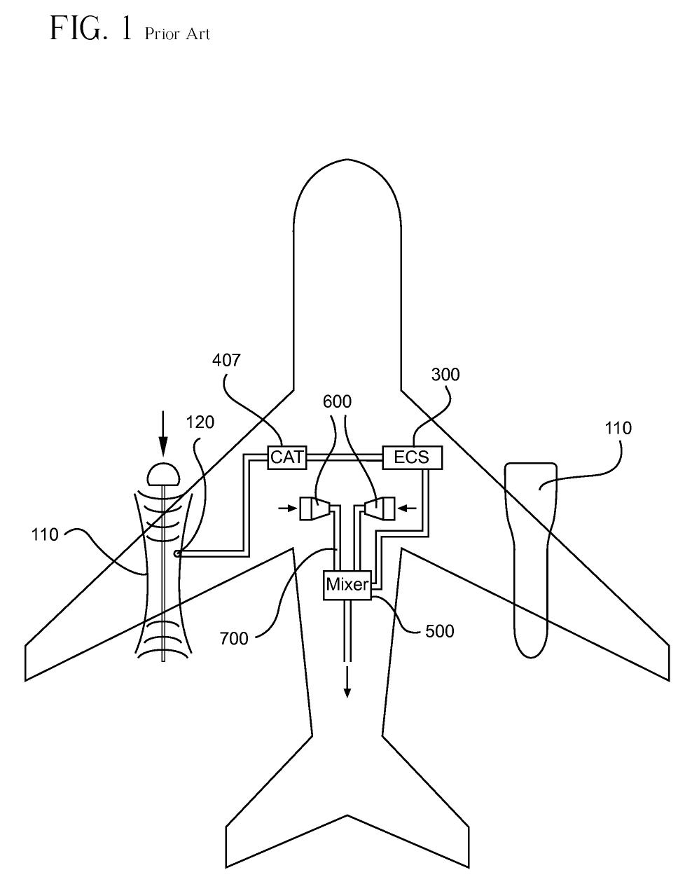

### DETAILED DESCRIPTION

The system for treating air and method for treating aircraft cabin air, according to one or more embodiments of the invention, may be more readily appreciated by reference to the Figures, which are merely exemplary in nature and in no way intended to limit the invention or its application or uses. Before describing these several exemplary embodiments of the invention, it is to be understood that the invention is not limited to the details of construction or process steps set forth in the following description. The invention is capable of other embodiments and of being practiced or being carried out in various ways.

Embodiments of the present invention relate an air treatment system with one or more catalysts disposed to treat the compressed air, recirculated air and/or the combined compressed and recirculated air. The air treatment system of the present invention includes one compressor or compressed air source, ECS, mixer, a recirculation air system and a catalyst.

As used throughout this application, the term “Environmental Control System” (abbreviated as “ECS”) shall include, without limitation, a system that controls one or more of the pressure, temperature, humidity and pollutant levels of the air supplied to the cabin, regardless of whether the air is bleed air or bleedless air (as defined herein). A mixer shall be defined to include any known means for combining air sources which can include the compressed air and recirculated air. The air treatment system may include a catalyst to remove the ozone from the bleed air. As used throughout this application, the terms “treat,” “remove” and “remove pollutants” shall cover at least conversion of ozone, carbon monoxide, hydrocarbons and VOCs and/or adsorption of the foregoing.

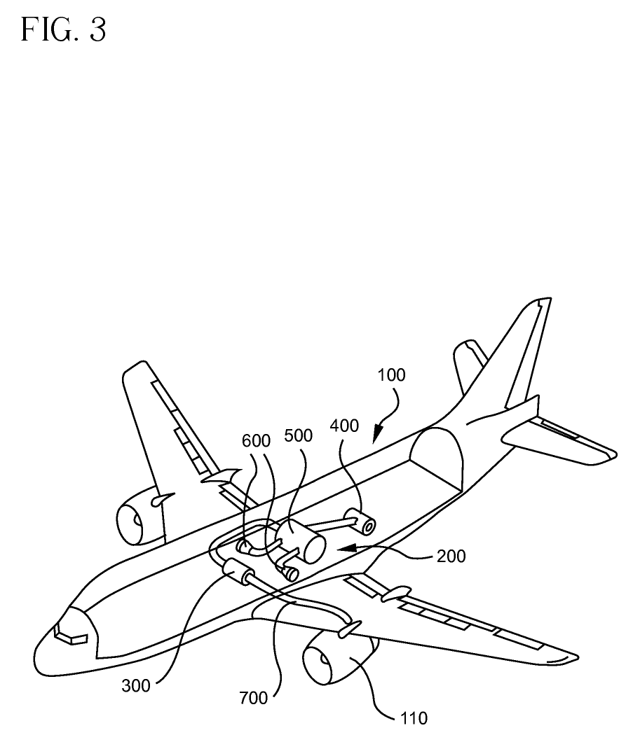

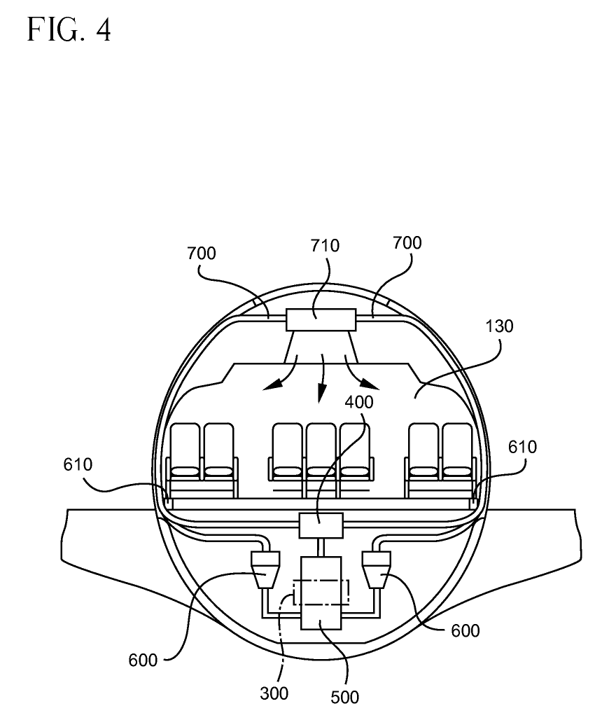

As shown in FIGS. 3 and 4, an aircraft 100 includes an air treatment system 200 to treat the air contained within the cabin and the air being supplied to the cabin. Such systems can be used in aircraft such as military, civil or commercial, or passenger aircraft.

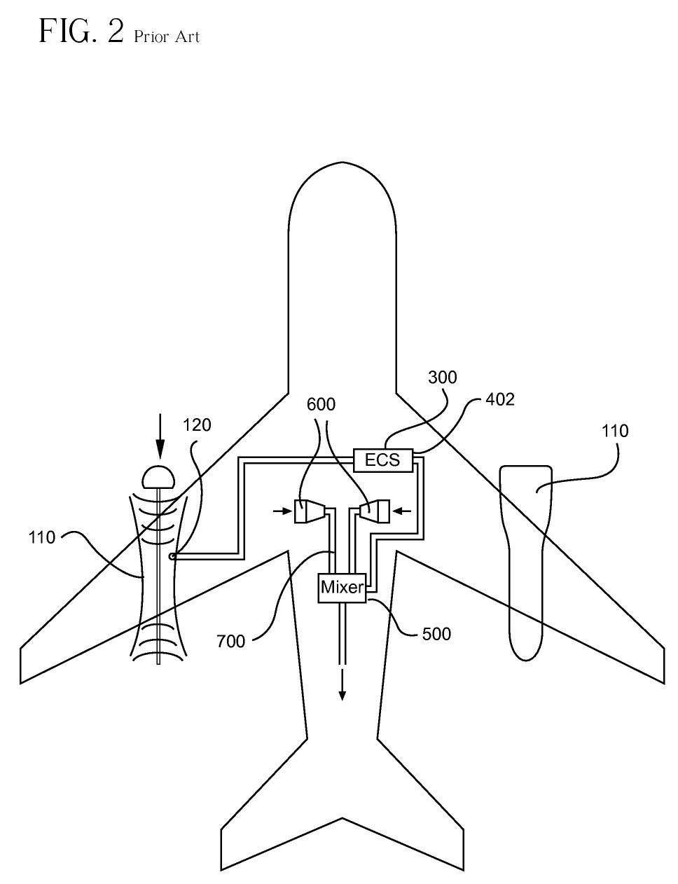

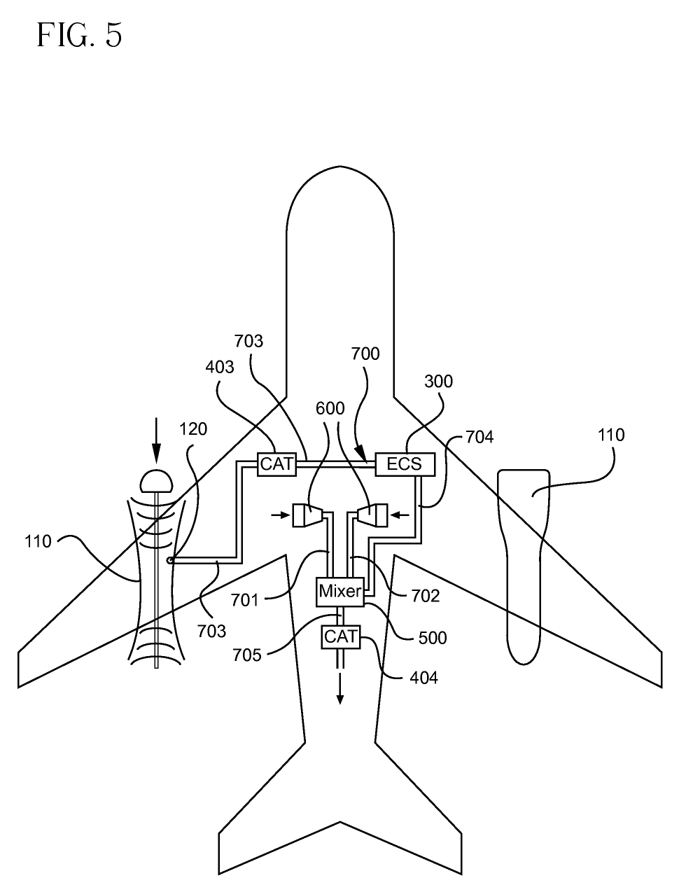

The air treatment system 200 includes a recirculation air system 600 which recirculates and filters the air within the cabin 130. In one or more embodiments, the recirculation air system 600 draws or takes in the air from the cabin 130 through the ceiling or from under floor spaces. As more clearly shown in FIG. 2, exhaust vents 610 are used to draw the air from the cabin 130 into the recirculation air system 600. As more clearly shown in FIG. 5, the recirculation air system 600 is in fluid communication with the air distribution duct system 700 via one or more conduits 701, 702. The recirculation air system 600 of one or more embodiments can include a plurality of exhaust vents and intake ports. The recirculation air system of such embodiments can also include multiple conduits or sets of conduits to allow fluid communication between the components of the air treatment system. Valves and other control systems can be used to regulate the amount of air recirculated by the recirculated air system and the timing of the recirculation, whether such recirculation is continuous or intermittent.

Typically, a portion of the recirculated air is treated while the remaining portion is directly exhausted from the aircraft. In one or more embodiments, about 50% of the recirculated air is exhausted through an exhaust system (not shown) while the remaining 50% is further treated by the air treatment system. The recirculation air system also includes one or more filters to remove contaminants from the air such as dust, lint or odors. In a specific embodiment, the recirculation air system includes high efficiency particulate air type filters (HEPA-type) to remove from the recirculated air bacteria and viruses produced by the passengers from the recirculated air.

As a portion of the air from the cabin is exhausted from the aircraft, the exhausted air is replaced by air from a stored source or an exterior source. In one or more embodiments, the air from the atmosphere outside of the aircraft is drawn in and compressed to replenish the air within the cabin. As previously mentioned, the air outside the aircraft has very low pressure and temperature, which must be regulated before it can be introduced to the cabin environment. In one or more embodiments, the compressed air is bleed air taken from within the engine of the aircraft. In a specific embodiment, compressed air is supplied from bleedless air or air that is not compressed by the engine of the aircraft. This air can be supplied from the atmosphere outside of the aircraft or air stored onboard the aircraft, such as high volume oxygen storage tanks, provides a source of compressed air that can be used to replenish the air within the cabin. In one embodiment, a combination of air from the outside atmosphere, which can be bleed or bleedless, and stored air is used to replenish the air exhausted from the cabin.

In one or more embodiments, air from the outside atmosphere enters the engines of the aircraft and thereafter, the air is directed to the air treatment system. FIGS. 5-9 show one engine of the aircraft supplying air to the air treatment system, however, it will be understood by one skilled in the art that all or some of the engines can be used to supply air to the air treatment system. Moreover, as otherwise described herein, the air can be supplied to the air treatment system from sources other than the engines of the aircraft, for example. In embodiments utilizing bleed air as compressed air, upon entering the engine 110, the outside or fresh air is compressed and heated to a higher pressure and temperature. A portion of this air flowing through the engine 1 10 is directed through the air treatment system 200 and through one or more delivery ports 120. The bleed air then travels through a second set of conduits 703 within the air distribution system 700 to the ECS 300.

In embodiments that utilize bleedless air as compressed air, air from the outside atmosphere is drawn in by a port or vent and compressed using an air compressor or other compressor unrelated to the engine. In one specific embodiment, stored air sources supply bleedless air to be used as compressed air.

As shown in FIGS. 5-9, the ECS 300 then treats the compressed air by regulating properties such as temperature, pressure and humidity. In one or more embodiments, the ECS includes air-conditioning packs which can cool the compressed air. After treatment by the ECS, the compressed air is directed through a third set of conduits 704 to a mixer 500 then combined with the recirculated air by the mixer 500. In one or more embodiments, the combined compressed air and recirculated air is then directed in fourth set of conduits 705 to a supply duct 710 which circulates the air to the cabin 130, as is more clearly shown in FIG. 4.

One or more catalysts 400 are used to remove pollutants from the compressed air, recirculated air and/or the combined compressed and recirculated air. Such pollutants can include ozone, VOCs, NOₓ, particulate matter and other undesired compounds. As otherwise discussed in this application, ozone is found in the atmosphere at higher altitudes and must be removed from air prior to being supplied to the aircraft cabin environment. In addition, the air in the atmosphere and the existing air in the cabin can also contain VOCs. Sources of VOCs within the aircraft environment include de-icing fluid used to prepare aircraft for operation, cleaning fluids used within the aircraft or by passengers, lubricating fluids, engine oils and alcoholic drinks served to passengers, among others. The amount of VOCs within the cabin can be high while the aircraft is on the ground, as well as during flight. The air within the aircraft can also contain NOₓ from the engine.

In FIG. 5, the air treatment system 200 includes one catalyst 403, which treats the compressed air before it is combined with the recirculated air and another catalyst 404, which treats the combined compressed and recirculated air prior to being supplied to the cabin. In one embodiment, the catalyst 404 can be integrated with the mixer 500. This can be done by coating the surfaces of the mixer with an appropriate catalyst or incorporating a catalyst unit in the mixer that contacts the stream of air flowing through the mixer 500. Disposing the catalyst 404 downstream of the mixer 500 or integrating the catalyst with the mixer 500 allows the pollutants to be removed from the recirculated air and allows additional amounts of pollutants to be removed from the compressed air. In addition to the other embodiments described herein, the additional or second catalyst of this particular embodiment also allows for existing air treatment systems to be retrofitted to conform to the embodiments described herein.

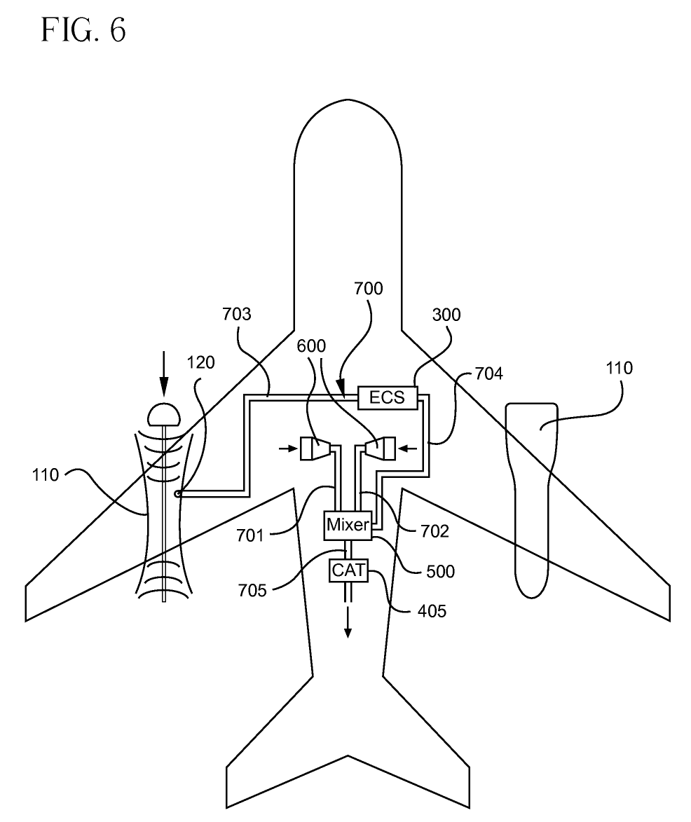

In FIG. 6, a single catalyst 405 is positioned downstream of the mixer 500 and in fluid communication with the fourth set of conduits 705 connecting the mixer to the cabin. The catalyst 405 is disposed to treat the combined compressed and recirculated air. In one embodiment, the catalyst 405 can be a separate unit. In an alternative embodiment, the can be integrated with the mixer 500 to treat the compressed and recirculated air as it is being combined. Combinations of a separate catalyst unit 405 and a catalyst integrated with the mixer can be utilized. Suitable catalysts for removing ozone and other pollutants are known and will be discussed in more detail herein.

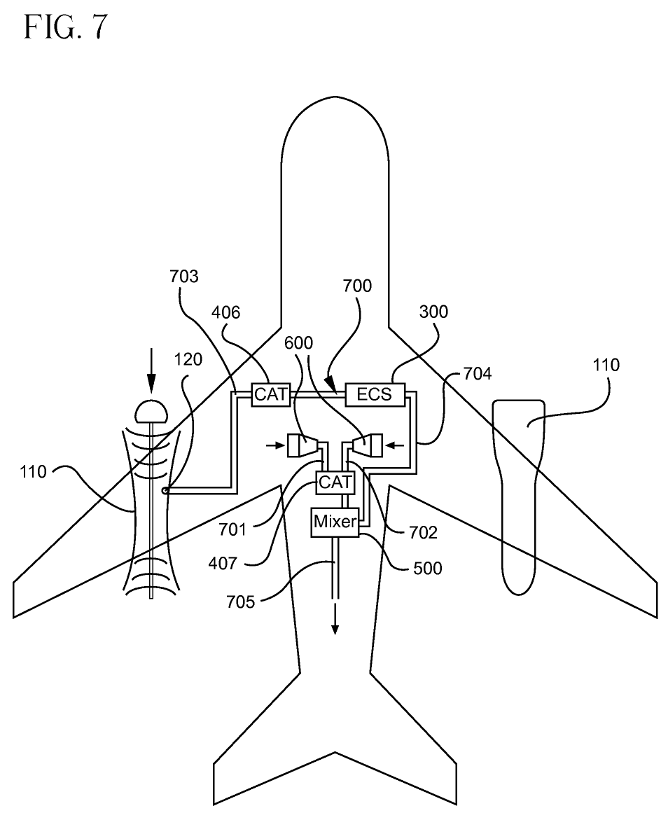

As shown in FIG. 7, a catalyst 406 is positioned to treat the compressed air prior to being combined with the recirculated air and a second catalyst 407 is positioned to treat the recirculated air prior to being combined with the compressed air. In FIG. 7, the catalyst 406 is in fluid communication with the set of conduits 703 between the compressor 110 and the ECS 300. The catalyst 407 is in fluid communication with the set of conduits 701, 702, the recirculation air system 600 and the mixer 500. In one or more embodiments, the catalyst 406 removes one pollutant while the catalyst 407 removes another. For example, catalyst 406 may remove ozone and catalyst 407 may remove VOCs, but it may also be in the reverse order. In a specific embodiment, the catalyst 406 is adapted to treat the compressed air at high temperatures, while the catalyst 407 is adapted to treat the recirculated air at lower temperatures.

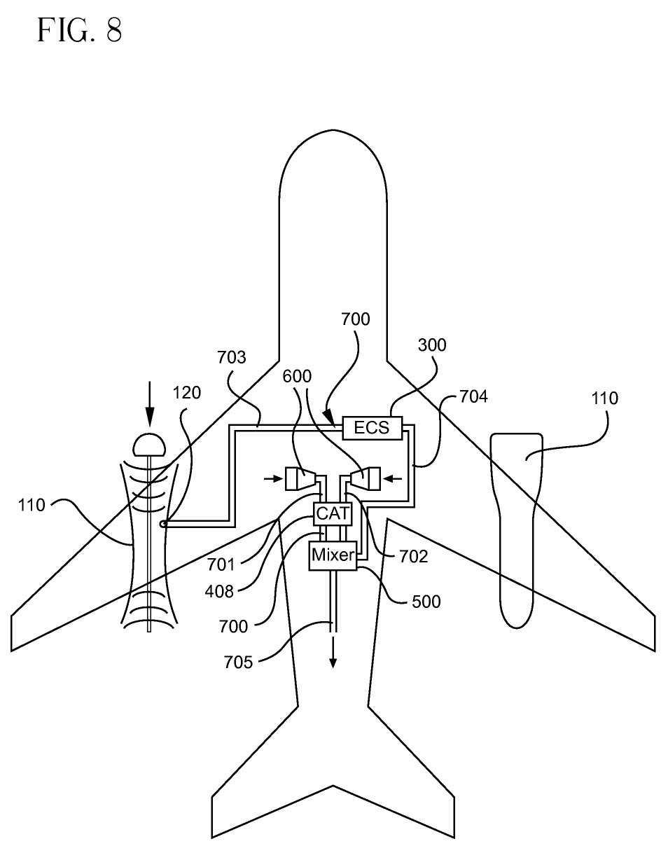

In FIG. 8, a catalyst 408 is disposed to remove pollutants from the recirculated air prior to being combined with the compressed air. During operation, the compressed air is mixed with the recirculated air and is delivered to the cabin. This air will then be continuously recirculated back to the air treatment system. The catalyst 408 shown in FIG. 8 is disposed in fluid communication with the set of conduits 701, 702, the recirculation air system 600 and the mixer 500. This configuration would allow the catalyst 408 to remove pollutants from the recirculated air, which can include compressed air.

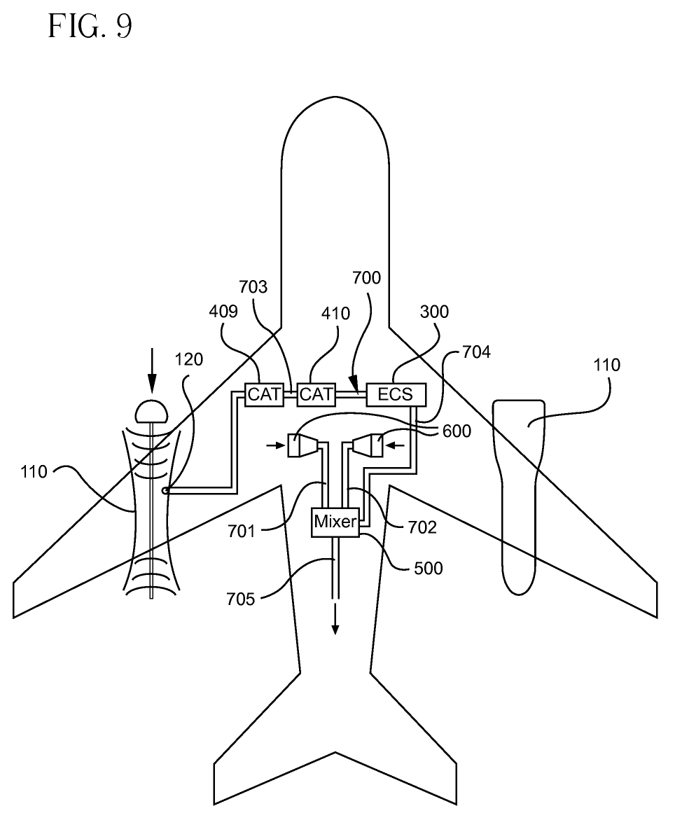

The air treatment system shown in FIG. 9 includes two catalysts 409, 410 disposed upstream of the ECS 300. In one or more embodiments, one of the two catalysts 409, 410 can be integrally formed or disposed on the ECS 300. According to another embodiment, one or both of the catalysts 409, 410 can be disposed in fluid communication with the first set of conduits 703, the compressor 110 and the ECS 300. One or both of the catalysts can be disposed on a heat exchanger which can be included in specific embodiments of the air treatment system. In one or more embodiments, one of the two catalysts 409, 410 is adapted to primarily remove one pollutant while the other of the two catalysts 409, 410 is adapted to primarily remove another pollutant. In such embodiments, catalyst 409 can primarily removes ozone while catalyst 410 removes VOCs. In another such embodiment, catalyst 409 can primarily removes ozone and NOx, while catalyst 410 primarily removes VOCs. In each embodiment, the catalysts can be positioned or adapted to remove any one or more of the pollutants while another catalyst can be positioned or adapted to remove different pollutants.

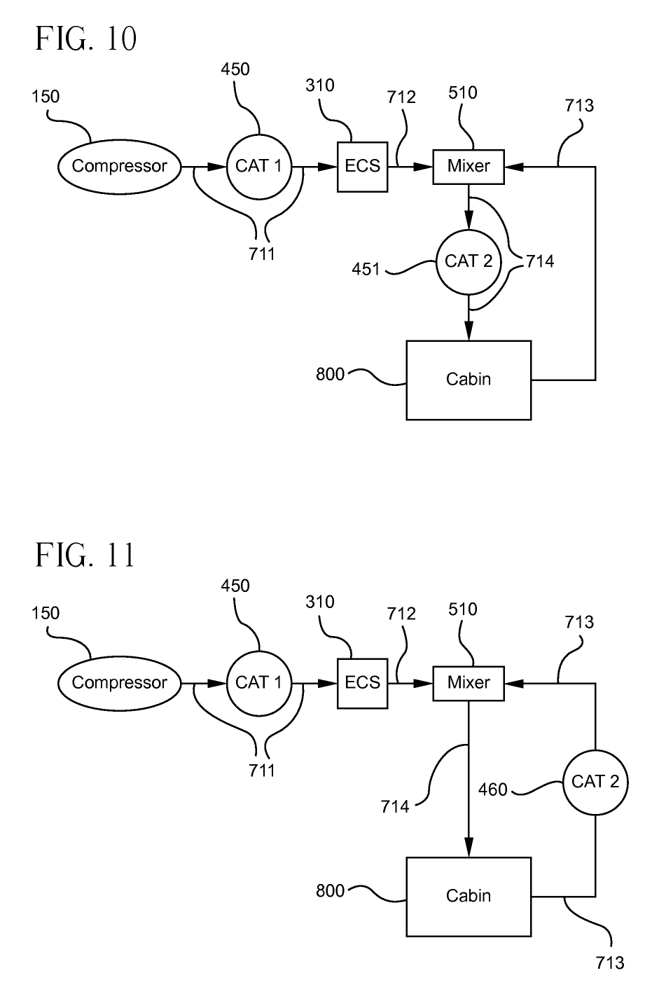

FIGS. 10-14 show one or more embodiments of air treatment systems which utilize bleedless air as compressed air. In FIG. 10, the air compressor 150 compresses bleedless air to form compressed air. The compressed air leaves the air compressor 150 and travels to the first catalytic system 450 and, thereafter, to an ECS 310 through a first duct system 711. The ECS 310 regulates the compressed air as otherwise described in this application. The compressed air then travels through a second duct system 712 to a mixer 510 where it is combined with recirculated air being supplied from the aircraft cabin 800 to the mixer 510 via a third duct system 713. The combined compressed air and recirculated air travel to a second catalytic system 451 and then to the aircraft cabin 800 through a fourth duct system 714.

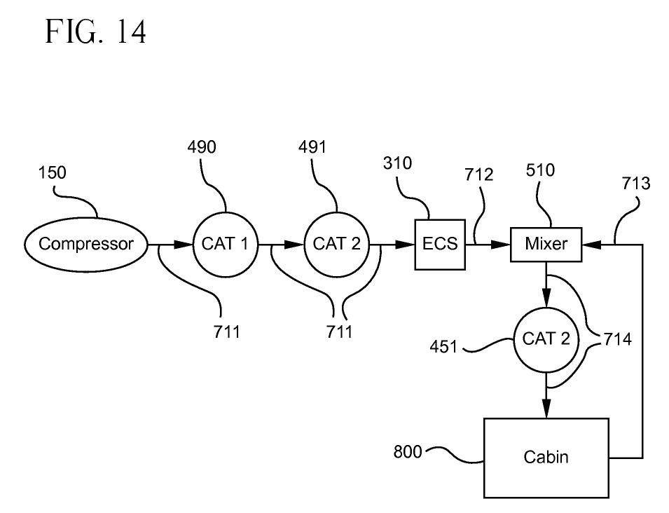

As otherwise described herein, the catalyst systems can disposed on the ducts which connect the air compressor, ECS, mixer and cabin. In one or more embodiments, the duct systems can include multiple segments which can operate separately or together with one another. In another embodiment, the duct system is adapted to allow one or more catalytic systems to be connected thereto, as more clearly shown in FIG. 14.

Referring to FIG. 11, the compressed air travels from the air compressor 150 to a first catalytic system 450, the ECS 310 and thereafter to the mixer 510 through first and second duct systems 711, 712. The compressed air is then combined with the recirculated air in the mixer 5 10. The recirculated air travels to a second catalytic system 460 and to the mixer 510 through the third duct system 713. The combined compressed air and recirculated air is then supplied to the aircraft cabin 800 through the fourth duct system 714.

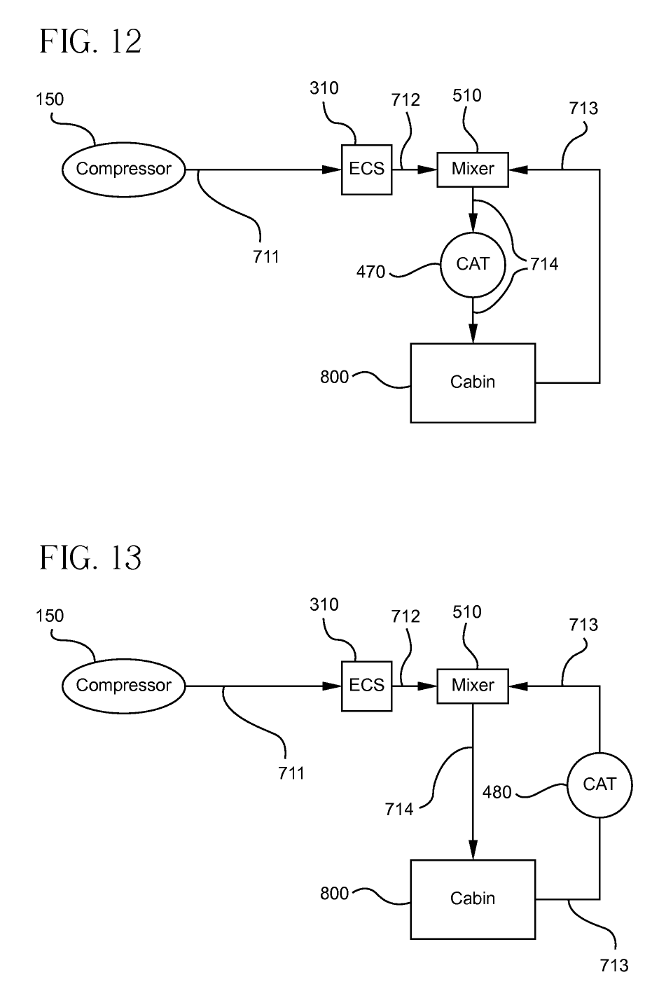

In FIG. 12, a third catalytic system 470 is disposed in fluid communication with the mixer 510, the aircraft cabin 800 and the fourth duct system 714. According to the embodiment shown in FIG. 12, the compressed air travels from the air compressor 150 to the ECS 310 and the mixer 510 via the first and second duct systems. The recirculated air travels to the mixer 510 through the third duct system 713 to be combined with the compressed air. The combined compressed and recirculated air leaves the mixer 510 through the fourth duct system 714 to the third catalytic system 470 before it is supplied to the aircraft cabin 800.

In FIG. 13, the recirculated air is supplied to the mixer 510 from the aircraft cabin 800 through the third duct system 713, where it is combined with the compressed air and supplied to the aircraft cabin 800 by the fourth duct system 714. In the embodiment of FIG. 13, the recirculated air passes through a third catalytic system 480 before reaching the mixer 510.

FIG. 14 shows a fourth and fifth catalytic system 490, 491 disposed upstream of the ECS 310 in fluid communication with the air compressor 150 and the first duct system 711. The compressed air is supplied by the air compressor 150 to the first duct system 711 where it passes through the fourth and fifth catalytic systems 490, 491 and is fed to the ECS 310. The compressed air is then fed to the mixer 510 by the second duct system 712 to be combined with the recirculated air provided to the mixer 510 by the third duct system 713. The combined compressed and recirculated air is then fed to the aircraft cabin 800 via the fourth duct system 714.

In air treatment systems which use more than one catalyst to treat the compressed air, recirculated air and/or combined compressed and recirculated air, the catalysts can be identical or different from one another. In each embodiment described herein, a catalyst can include a discrete system or separate component in fluid communication with the air distribution duct system. Further, such catalysts can be in fluid communication with the ECS and/or the mixer. The catalysts described in each embodiment of the present invention can comprise a coating disposed on or impregnated onto the inner surface of the air distribution duct system, the ECS and/or the mixer. The coating or layer can be applied by any suitable method such as coating, dipping spraying, electric arc spraying, plasma spraying or using any other suitable technique. In a one embodiment, the catalyst can be in the form of a discrete catalyst, such as in the form of a foam, a honeycomb catalyst, beads, plates, tubes and other catalysts. There is no particular limitation on the shape or configuration of the catalyst.

The catalyst may be used in any configuration, shape or size, which exposes it to the gas to be treated. For example, the catalyst can be conveniently employed in particulate form or the catalyst can be deposited onto a solid monolithic carrier. When the particulate form is desired, the catalyst can be formed into shapes such as tablets, pellets, granules, rings, spheres, etc. The particulate form is especially desirable where large volumes of catalysts are needed, and for use in circumstances in which frequent replacement of the catalyst may be desired. In circumstances in which less mass is desirable or in which movement or agitation of particles of catalyst may result in attrition, dusting and resulting loss of dispersed metals or oxides or undue increase in pressure drop across the particles due to high gas flows, a monolithic form is preferred.

In the employment of a monolithic form, it is usually most convenient to employ the catalyst as a thin film or coating deposited on an inert carrier material which provides the structural support for the catalyst. The inert carrier material can be any refractory material such as ceramic or metallic materials. It is desirable that the carrier material be unreactive with the catalytic components and not be degraded by the gas to which it is exposed. Examples of suitable ceramic materials include sillimanite, petalite, cordierite, mullite, zircon, zircon mullite, spodumene, alumina-titanate, etc. Additionally, metallic materials, which are within the scope of this invention, include metals and alloys such as aluminum, titanium, magnesium, stainless steel. Other metals and alloys within the scope of the invention are disclosed in U.S. Pat. No. 3,920,583, incorporated herein by reference, which are oxidation resistant and are otherwise capable of withstanding high temperatures. For the treatment of gases containing halocarbons, ceramic materials may be preferred.

The monolithic carrier material can best be utilized in any rigid unitary configuration, which provides a plurality of pores or channels extending in the direction of gas flow. In one embodiment the configuration can be a honeycomb configuration. The honeycomb structure can be used advantageously in either unitary form, or as an arrangement of multiple modules. The honeycomb structure is usually oriented such that gas flow is generally in the same direction as the cells or channels of the honeycomb structure. For a more detailed discussion of monolithic structures, refer to U.S. Pat. No. 3,785,998 and U.S. Pat. No. 3,767,453, which are incorporated herein by reference.

If particulate form is desired, the catalyst can be formed into granules, spheres or extrudates by means well known in the industry. For example, the catalyst powder can be combined with a binder such as a clay and rolled in a disk pelletizing apparatus to give catalyst spheres. The amount of binder can vary considerably but for convenience is present from about 10 to about 30 weight %.

If a monolithic form is desired, the catalyst of this invention can be deposited onto the monolithic honeycomb carrier by conventional means. For example, a slurry can be prepared by means known in the art such as combining the appropriate amounts of the catalyst of this invention in powder form, with water. The resultant slurry is ball-milled for about 8 to 18 hours to form a usable slurry. Other types of mills such as impact mills can be used to reduce the milling time to about 1-4 hours. This slurry can now be used to deposit a thin film or coating of catalyst of this invention onto the monolithic carrier by means well known in the art. Optionally, an adhesion aid such as alumina, silica, zirconium silicate, aluminum silicates, zirconium acetate, organic polymers or silicones can be added in the form of an aqueous slurry or solution. A common method involves dipping the monolithic carrier into said slurry, blowing out the excess slurry, drying and calcining in air at a temperature of about 450° C. to about 600° C. for about 1 to about 4 hours. This procedure can be repeated until the desired amount of catalyst of this invention is deposited on said monolithic honeycomb carrier. It is desirable that the catalyst of this invention be present on the monolithic carrier in an amount in the range of about 1-4 g of catalyst per in³ of carrier volume and preferably from about 1.5-3g/in³.

In one embodiment, the discrete catalyst is in the form of a flexible catalyst that can be conformed to fit the shape of existing components. In such embodiments, the flexible catalysts can be inserted into existing components of air treatment systems, such as the air distribution duct system 700, mixer 500 or ECS 300. An exemplary embodiment of such a flexible member is described in U.S. application Ser. No. 10/612,658, published as United States Application Publication No. 20040038819, entitled Pliable Metal Catalyst Carriers, Conformable Catalyst Members Made Therefrom and Methods of Installing the Same, the entire content of which is incorporated herein by reference. In a particular embodiment, the flexible tube is (a) a length of pliable tube having (i) an exterior surface, (ii) an interior surface which defines a tube passageway, and (iii) a plurality of perforations extending along at least a portion of the length of the tube; (b) one or more annular baffles extending radially outwardly from the exterior surface of the tube; and (c) one or more interior closures closing the tube passageway but leaving at least some of the perforations open. The annular baffles and the interior closures are staggered relative to each other along the length of the tube, and the perforations are disposed along the length of the tube at least coextensively with the annular baffles and the interior closures. The flexible tube is dimensioned and configured to be mounted within an existing component having an open discharge end, the carrier having coated thereon an anchor layer, e.g., an intermetallic anchor layer, for having a catalytic coating applied thereto. The carrier has a distal end and a proximal end, and the proximal end comprises a mounting member dimensioned and configured to be secured to the open discharge end of component when at least a part of the carrier is disposed within the component.

In another embodiment, the catalyst can be disposed on or impregnated onto air distribution duct system components or conduits which can be placed at various locations within an air treatment system. Such embodiments would allow existing parts of air distribution duct systems to be replaced with parts containing catalysts. As mentioned above, any suitable technique for applying the catalyst to the existing components can be utilized.

The specific catalyst utilized according to embodiments of the invention can be any catalyst that is suitable for treating aircraft cabin air. In one or more embodiments the catalyst includes a component such as Au, Ag, Ir, Pd, Pt, Rh, Ni, Co, Mn, Cu, Fe, vanadia, zeolite, titania, ceria and mixtures thereof and other compositions known for removing ozone, VOCs, NOx and other pollutants. These compositions can be used in metal or oxide form. Suitable supports that can be used in each embodiment described herein include refractory metal oxide such as alumina, titania, manganese oxide, manganese dioxide and cobalt dioxide. In one or more embodiments, the catalyst support can further include silica. One or more embodiments, a honeycomb support is used, wherein the honeycomb is a ceramic or metal. A specific type of catalyst that can be used according to one or more embodiments of the present invention is described in U.S. Pat. No. 5,422,331, the entire content of which is incorporated herein by reference. In particular, the catalyst may comprise (a) an undercoat layer comprising a mixture of a fine particulate refractory metal oxide and a sol selected from the class consisting of one or more of silica, alumina, zirconia and titania sols; and (b) an overlayer comprising a refractory metal oxide support on which is dispersed at least one catalytic metal component. The catalytic metal component may include a palladium component. The sol may be a silica sol. The overlayer refractory metal oxide comprises activated alumina. In one or more embodiments, the refractory metal oxide is a silica alumina comprising from about 5 to 50 percent by weight silica and from about 50 to 95 percent by weight alumina. In specific embodiments, the catalytic metal component comprises a palladium component and a manganese component, and the palladium may be dispersed on the refractory metal oxide with a palladium salt such as palladium tetraamine hydroxide or palladium tetraamine nitrate. The amount of the palladium component may be from about 50 to about 250 g/ft³.

Other suitable ozone abatement catalysts are described in U.S. Pat. Nos. 4,343,776; 4,206,083; 4,900,712; 5,080,882; 5,187,137; 5,250,489; 5,422,331; 5,620,672; 6,214,303; 6,340,066; 6,616,903; and 7,250,141, which are hereby incorporated by reference, are useful for the practice of the present invention.

An illustrative example is U.S. Pat. No. 6,616,903, which discloses a useful ozone treating catalyst comprises at least one precious metal component, specifically a palladium component dispersed on a suitable support such as a refractory oxide support. The composition comprises from 0.1 to 20.0 weight %, and specifically 0.5 to 15 weight % of precious metal on the support, such as a refractory oxide support, based on the weight of the precious metal (metal and not oxide) and the support. Palladium may be used in amounts of from 2 to 15, more specifically 5 to 15 and yet more specifically 8 to 12 weight %. Platinum may be used at 0.1 to 10, more specifically 0.1 to 5.0, and yet more specifically 2 to 5 weight %. Palladium may be used to catalyze the reaction of ozone to form oxygen. The support materials can be selected from the group recited above. In one embodiment, there can additionally be a bulk manganese component, or a manganese component dispersed on the same or different refractory oxide support as the precious metal, specifically palladium component. There can be up to 80, specifically up to 50, more specifically from 1 to 40 and yet more specifically about 5 to 35 weight % of a manganese component based on the weight of palladium and manganese metal in the pollutant treating composition. Stated another way, there is specifically about 2 to 30 and specifically 2 to 10 weight % of a manganese component. The catalyst loading is from 20 to 250 grams and specifically about 50 to 250 grams of palladium per cubic foot (g/ft³) of catalyst volume. The catalyst volume is the total volume of the finished catalyst composition and therefore includes the total volume of air conditioner condenser or radiator including void spaces provided by the gas flow passages. Generally, the higher loading of palladium results in a greater ozone conversion, i.e., a greater percentage of ozone decomposition in the treated air stream.

Another illustrative example from U.S. Pat. No. 6,616,903 comprises a catalyst composition to treat ozone comprising a manganese dioxide component and precious metal components such as platinum group metal components. While both components are catalytically active, the manganese dioxide can also support the precious metal component. The platinum group metal component specifically is a palladium and/or platinum component. The amount of platinum group metal compound specifically ranges from about 0.1 to about 10 weight % (based on the weight of the platinum group metal) of the composition. Specifically, where platinum is present it is in amounts of from 0.1 to 5 weight %, with useful and preferred amounts on pollutant treating catalyst volume, based on the volume of the supporting article, ranging from about 0.5 to about 70 g/ft³. The amount of palladium component specifically ranges from about 2 to about 10 weight % of the composition, with useful and preferred amounts on pollutant treating catalyst volume ranging from about 10 to about 250 g/ft³.

Another example of a suitable catalyst material can be found in U.S. Pat. No. 6,517,899, the entire content of which is incorporated herein by reference. U.S. Pat. No. 6,517,899 describes catalyst compositions comprising manganese compounds including manganese dioxide, including non stoichiometric manganese dioxide (e.g., MnO_{(1.5-20)}), and/or Mn₂O₃. Such manganese dioxides, which are nominally referred to as MnO₂ have a chemical formula wherein the molar ratio of manganese to oxide is about from 1.5 to 2.0, such as Mn₈O₁₆. Up to 100 percent by weight of manganese dioxide MnO₂ can be used in catalyst compositions to treat ozone and other undesired components in the air. Alternative compositions which are available comprise manganese dioxide and compounds such as copper oxide alone or copper oxide and alumina.

Useful manganese dioxides are alpha manganese dioxides nominally having a molar ratio of manganese to oxygen of from 1 to 2. Useful alpha manganese dioxides are disclosed in U.S. Pat. No. 5,340,562 to O'Young, et al.; also in O'Young, Hydrothermal Synthesis of Manganese Oxides with Tunnel Structures presented at the Symposium on Advances in Zeolites and Pillared Clay Structures presented before the Division of Petroleum Chemistry, Inc. American Chemical Society New York City Meeting, Aug. 25-30, 1991 beginning at page 342, and in McKenzie, the Synthesis of Birnessite, Cryptomelane, and Some Other Oxides and Hydroxides of Manganese, Mineralogical Magazine, December 1971, Vol. 38, pp. 493-502. Suitable alpha manganese dioxide can have a 2×2 tunnel structure which can be hollandite (BaMn₈O₁₆×H₂O), cryptomelane (KMn₈O₁₆×.H₂O), manjiroite (NaMn₈O₁₆.×H₂O) and coronadite (PbMn₈O₁₆.×H₂O).

The catalyst composition may comprise a binder as described below with preferred binders being polymeric binders. The composition can further comprise precious metal components with preferred precious metal components being the oxides of precious metal, preferably the oxides of platinum group metals and most preferably the oxides of palladium or platinum also referred to as palladium black or platinum black. The amount of palladium or platinum black can range from 0 to 25%, with useful amounts being in ranges of from about 1 to 25 and 5 to 15% by weight based on the weight of the manganese component and the precious component.

It may also be desirable to use of compositions comprising the cryptomelane form of alpha manganese oxide, which also contain a polymeric binder A portion of the cryptomelane may be replaced by up to 25%, for example, from 15-25% parts by weight of palladium black (PdO. A suitable cryptomelane manganese dioxide has from 1.0 to 3.0 weight percent potassium, typically as K₂O, and a crystallite size ranging from 2 to 10 nm. The cryptomelane can be made by reacting a manganese salt including salts selected from the group consisting MnCl₂, Mn(NO₃)₂, MnSO₄ and Mn(CH₃ COO)₂ with a permanganate compound. Cryptomelane is made using potassium permanganate; hollandite is made using barium permanganate; coronadite is made using lead permanganate; and manjiroite is made using sodium permanganate. It is recognized that the alpha manganese useful in the present invention can contain one or more of hollandite, cryptomelane, manjiroite or coronadite compounds. Even when making cryptomelane minor amounts of other metal ions such as sodium may be present. Useful methods to form the alpha manganese dioxide are described in the above references which are incorporated by reference.

The cryptomelane may be “clean” or substantially free of inorganic anions, particularly on the surface. Such anions could include chlorides, sulfates and nitrates which are introduced during the method to form cryptomelane. An alternate method to make the clean cryptomelane is to react a manganese carboxylate, preferably manganese acetate, with potassium permanganate. It has been found that the use of such a material which has been calcined is “clean”.

The adhesion of catalytic and adsorption compositions to surfaces, e.g., metal surfaces, may be improved by the incorporation of clay minerals as adhesion promoters. Such clay minerals include but are not limited to attapulgite, smectites (e.g., montmorillonite, bentonite, beidellite, nontronite, hectorite, saponite, etc.), kaolinite, talc, micas, and synthetic clays (e.g., Laponite sold by Southern Clay Products). The use of clay minerals in manganese dioxide catalyst slurries has been demonstrated to improve the adhesion of the resulting catalyst coatings to metal surfaces.

Additional suitable metal surface adhesion promoting materials for catalytic and adsorption compositions are water based silicone resin polymer emulsions The use of water based silicone polymer emulsions can improve the adhesion of e.g. manganese dioxide catalyst coatings to metal surfaces. In one embodiment, the benefit of the silicone polymer is obtained by incorporating the water based silicone latex emulsion into the catalyst slurry formulation prior to coating. In an additional embodiment, however, the benefit of the silicone polymer can be obtained by application of a dilute solution of the silicone latex over the dried catalyst coating. The silicone latex is believed to penetrate the coating, and upon drying, leaves a porous cross-linked polymer “network” which significantly improves adhesion of the coating.

One or more embodiments of the present invention include a method of treating aircraft cabin air. In these embodiments, compressed air is drawn into the treatment system from a compressor. The compressor can form part of the existing aircraft engine or can be separate from the engine. The compressor compresses air that can be drawn in from outside the aircraft or supplied by a stored air source. In another embodiment, the compressed air is a combination of air drawn from outside the aircraft and/or stored air. The method for treating aircraft cabin air in an alternative embodiment further includes combining the air drawn from outside the aircraft with the stored air and can also include cooling the compressed air.

After drawing in the compressed air into the system, the method of treating the aircraft cabin air further includes recirculating the existing air within the cabin or cabin air into the treatment system and filtering the recirculated air to remove contaminants. The steps of drawing in the compressed air and recirculating the cabin can occur simultaneously or, in one or more embodiments, the cabin air is recirculated to the treatment system before the compressed air is drawn in. In a specific embodiment, the compressed air is further regulated to control humidity levels, temperature and pressure.

The method for treating aircraft cabin air also provides for catalytically removing one or more pollutants from the recirculated cabin air and, thereafter, mixing the cabin air with the compressed air and delivering the combined air to the cabin. In one or more embodiments, the method for treating aircraft cabin air further includes catalytically removing one or more pollutants from the mixed compressed air and recirculated cabin air. In an alternative embodiment, pollutants are catalytically removed from compressed air before it is mixed with the recirculated cabin air and/or from the recirculated air before it is mixed with the compressed air.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

What is claimed is:

1. A system for treating air comprising:
an air distribution duct system for providing treated air to an aircraft cabin in fluid communication with a compressor that delivers compressed air into the air distribution duct system;
a delivery port for delivering compressed air from the compressor into the air distribution duct system;
an environmental control system downstream from the delivery port for treating the compressed air;
a recirculation air system for providing recirculated air from the cabin to the air distribution duct system;
a mixer downstream from the environmental control system and in fluid communication with air flowing from the environmental control system and the recirculated air, the mixer operative to combine the compressed air and the recirculated air; and
a first catalyst in fluid communication with at least the recirculated air and optionally the compressed air flowing through the ECS, the catalyst adapted to remove one or more pollutants from one or both of the compressed air and recirculated air.

2. The system of claim 1, wherein the first catalyst is located in fluid communication with the air distribution duct system.

3. The system of claim 2, wherein the first catalyst is a coating disposed on an inner surface of the air distribution duct system.

4. The system of claim 1, further comprising a second catalyst in fluid communication with the compressed air and is adapted to remove one or more pollutants from the compressed air prior to being combined with the recirculated air.

5. The system of claim 4, wherein the second catalyst is a coating disposed on an inner surface of the air distribution duct system

6. The system of claim 1, wherein the first catalyst removes one or more pollutants from the recirculated air prior to being combined with the compressed air.

7. The system of claim 1, wherein the first catalyst is in fluid communication with the combined compressed air and recirculated air.

8. The system of claim 1, further comprising a third catalyst upstream of the environmental control system and in fluid communication with the compressed air, wherein the first catalyst is disposed upstream of the environmental control system.

9. The system of claim 8, wherein one of the first or third catalysts is integrally formed with the environmental control system.

10. The system of claim 1, wherein the catalyst is disposed on the mixer.

11. The system of claim 7, wherein the catalyst is disposed on the mixer.

12. The system of claim 1, wherein the compressed air comprises one of bleed air, bleedless air and combinations thereof.

13. The system of claim 1, wherein the one or more pollutants is one or more of ozone, volatile organic compounds and NOx.

14. The system of claim 8, wherein one of the first or third catalysts removes ozone and the other of the first or third catalyst removes volatile organic compounds.

15. The system of claim 1, further comprising a filter in fluid communication with the recirculation air system for removing contaminants from the recirculated air.

16. The system of claim 1, further comprising an air conditioning pack in fluid communication with the environmental control system and the mixer for cooling the compressed air.

17. A method of treating aircraft cabin air comprising:
drawing compressed air to a treatment system from a compressor;
recirculating cabin air to the treatment system to catalytically remove one or more pollutants from the cabin air;
mixing the compressed air with the cabin air to provide mixed air; and
delivering the mixed air to the cabin.

18. The method of claim 17, further comprising catalytically removing one or more pollutants from the mixed air.

19. The method of claim 17, further comprising catalytically removing one or more pollutants from the compressed air prior to mixing with the cabin air.

20. The method of claim 17, further comprising filtering the cabin air to remove contaminants.

21. The method of claim 17, wherein the one or more pollutants is one or more of ozone, volatile organic compounds and NOx.

22. The method of claim 17, further comprising cooling the compressed air prior to mixing with the cabin air.
